(19) United States
(12) Patent Application Publication
(10) Pub. No.: US 2012/0233021 A1
(43) Pub. Date: Sep. 13, 2012

(54) Online Transaction System

(75) Inventor: Hans Ehmann, Port Adelaide (AU)

(73) Assignee: NEVILLE SMITH & CO (SA) PTY LTD, Port Adelaide (AU)

(21) Appl. No.: 13/395,838

(22) PCT Filed: Sep. 14, 2010
(86) PCT No.: PCT/AU2010/001190

§ 371 Date: May 25, 2012

(30) Foreign Application Priority Data
Sep. 14, 2009 (AU) 2009904432

(51) Int. Cl. G06Q 30/06

(52) U.S. Cl. 705/26.41

(57) ABSTRACT

A method and system for carrying out an online transaction is disclosed. The transaction occurs between a customer having a financial account with a nominated financial institution and an online vendor and includes initiating a transaction server by the online vendor for the customer to conduct the online transaction for a purchase amount; selecting by the customer the nominated financial institution from a list of financial institutions provided by the transaction server and then transferring by the transaction server the customer to the nominated financial institution on selection of the nominated financial institution. The method further includes transacting between the nominated financial institution and the transaction server a first financial transaction for a transaction amount related to the purchase amount and then further transacting between the transaction server and the online vendor's financial institution a second transaction for the purchase amount in satisfaction of the online transaction.

### CLAIM OF PRIORITY

The present application for patent claims priority from Australian Provisional Patent Application No. 2009904432 entitled “Online Transaction System”, filed 14 Sep. 2009, which is hereby expressly incorporated by reference herein in its entirety.

### TECHNICAL FIELD

The present invention relates to method and system for carrying out online transactions. In a particular form the present invention relates to an online transaction system for carrying out secure and anonymous transactions.

### BACKGROUND

With the advent of the Internet it has been possible to carry online transactions in a number of different ways. The typical scenario for an online transaction involves a purchaser entering a vendor's website and selecting the goods and/or services that wished to be purchased. Often a “shopping cart” analogy is used for the online transaction system where a purchaser adds or deletes items from a virtual shopping cart. Once they have decided upon which items they wish to purchase, the purchaser then proceeds to a virtual “checkout” at which point the purchaser's credit card details are entered by the purchaser and captured by the online transaction system for authorisation and verification. While standard navigation of a vendor's website occurs under Hypertext Transfer Protocol (HTTP), transactions involving the use of credit card details will be encrypted by employing a Secure Socket Layer (SSL) over HTTP which ensures that user web page requests and their contents are encrypted. This ensures that credit card details cannot be captured by a third party by the simple monitoring of network traffic to the vendor's website.

Despite the encryption of network traffic, online transaction systems of this variety still have the serious disadvantage that credit card details including the serial number, expiry date and purchasers name are often stored by the vendor in a database for accounting purposes. Unfortunately, vendors often do not secure their information technology systems and there are many examples of databases of this type being penetrated by online “hackers” who retrieve this information and who are then able to either use this information to carry out fraudulent online purchases or on sell this information to other criminal parties. Further, dishonest employees who have access to the credit card details may use these details for their own fraudulent purchases or alternatively on sell this information to third parties.

While the credit provider will almost always honour these fraudulent transactions, the original owner of the credit card will have to prove to the credit provider that the transaction did not occur as a result of their undue disclosure of their credit card details. From the perspective of the credit provider, the honouring of these fraudulent transactions represents a significant and growing impost on their business. Another significant drawback of these systems is that the online transaction is not in any way anonymous i.e. the purchaser can be easily linked to any transaction by their credit card details. In an attempt to address some of these disadvantages, a further card security code (CSC) is employed which is printed on the physical credit card and then quoted by a purchaser when carrying out an online transaction. As the CSC is not stored by the vendor, this in theory improves the security of online transactions. However, while the employment of a CSC ensures that the person carrying out the online transaction is in physical possession of the relevant credit card it cannot ensure that this person is actually authorised to carry out the online transaction.

In one attempt to address the disadvantages of standard online transaction systems, a purchaser at the checkout stage is provided with an account number in which the purchaser is able to directly deposit funds, usually electronically, to the vendor. In this scenario, the purchaser or customer will first provisionally purchase the goods on the vendor's website and be provided with the vendor's account details and a unique transaction identification number. The vendor then goes to their financial institution's web site and directly deposit funds amounting to the purchase price of the goods and or services using the unique transaction identification number to identify the purchase.

Once these funds have been confirmed as being transferred, the vendor will then deliver the goods and/or services. While direct payment systems such as this provide the vendor with increased certainty that the money has been deposited, these types of systems are more inconvenient for the purchaser as they have to go through the extra steps of being provided with the vendor's account details and a unique transaction identification number and then use this information to manually transfer money from their financial institution to the vendor in a separate step. Further, there may be added difficulties when attempting to transfer funds between a purchaser's account in one country to the vendor's financial institution in another country. In addition to this inconvenience, the transaction may still be easily traced to the purchaser by virtue of the unique transaction identification number and financial institutions transaction record for the transfer of the purchaser's money to the vendor's account.

There is therefore a need for an online transaction system that is capable of allowing a purchaser to conveniently carry out secure and relatively anonymous transactions with a vendor.

### SUMMARY

In a first aspect, the present invention accordingly provides a method for carrying out an online transaction between a customer having a financial account with a nominated financial institution and an online vendor, the method including:
initiating a transaction server by the online vendor for the customer to conduct the online transaction for a purchase amount;
selecting by the customer the nominated financial institution from a list of financial institutions provided by the transaction server;
transferring by the transaction server the customer to the nominated financial institution on selection of the nominated financial institution;
transacting between the nominated financial institution and the transaction server a first financial transaction for a transaction amount related to the purchase amount; and
further transacting between the transaction server and the online vendor's financial institution a second transaction for the purchase amount in satisfaction of the online transaction.

In another form, the step of transferring by the transaction server the customer to the nominated financial institution includes the nominated financial institution invoking its own interface page for the customer to access the nominated financial institution.

In another form, the step of transacting between the nominated financial institution and the transaction server includes the customer selecting the financial account from which to carry out the first financial transaction.

In another form, the financial account is a credit card account and the first financial transaction is a credit card transaction.

In another form, the financial account is a savings or cheque account and the first financial transaction is an electronic funds transfer.

In another form, the step of transferring the customer by the transaction server to the nominated financial institution includes calculating the transaction amount and providing the transaction amount to the nominated financial institution.

In another form, the step of calculating the transaction amount includes incorporating a transaction service fee.

In another form, the step of calculating the transaction amount includes incorporating a currency conversion fee.

In a second aspect the present invention accordingly provides a system for carrying out an online transaction between a customer having a financial account with a nominated financial institution and an online vendor, the system including:
a transaction server initiated by the online vendor for the customer to conduct the online transaction for a purchase amount;
the transaction server providing selection means to allow the customer to select the nominated financial institution from a list of financial institutions provided by the transaction server;
the transaction server operable to transfer the customer to the nominated financial institution on selection of the nominated financial institution;
the transaction server operable to carry out a first transaction between the nominated financial institution and the transaction server for a transaction amount related to the purchase amount; and
the transaction server then operable to carry out a second transaction between the transaction server and the online vendor's financial institution for the purchase amount in satisfaction of the online transaction.

In another form, on transferring by the transaction server of the customer to the nominated financial institution, the nominated financial institution invokes its own interface page for the customer to access the nominated financial institution.

In another form, the transaction between the nominated financial institution and the transaction server includes selection means for the customer to select the financial account from which to carry out the first financial transaction.

In another form, the financial account is a credit card account and the first financial transaction is a credit card transaction.

In another form, the financial account is a savings or cheque account and the first financial transaction is an electronic funds transfer.

In another form, on transferring by the transaction server of the customer to the nominated financial institution, the transaction server calculates the transaction amount and provides the transaction amount to the nominated financial institution.

In another form, the transaction amount includes a transaction service fee.

In another form, the transaction amount includes a currency conversion fee.

A user interface for carrying out an online transaction between a customer having a financial account with a nominated financial institution and an online vendor, the user interface implemented on a computer display operated by the customer, the user interface including:
an online vendor screen displayed on the computer display and provided by the online vendor to conduct the online transaction for a purchase amount, the online vendor screen including a ininitiating portion operable by the customer for displaying a transaction server screen on the computer display, the transaction server screen provided by a transaction server and including a selection portion to allow the customer to select the nominated financial institution from a list of financial institutions;
a login screen displayed on the computer display, the login screen provided by the nominated financial institution on selection of the nominated financial institution; and
a payment screen provided by the nominated financial institution to carry out a transaction for a transaction amount in satisfaction of the online transaction with the online vendor.

In another form, the payment screen includes a display of a transaction service fee for inclusion in the transaction amount.

In another form, the payment screen includes a display of a currency conversion fee for inclusion in the transaction amount.

In another form, the payment screen includes a list of accounts of the customer for payment of the transaction amount.

In another form, the user interface is implemented to be accessed by a web browser.

### BRIEF DESCRIPTION OF THE DRAWINGS

Illustrative embodiments of the present invention will be discussed with reference to the accompanying drawings wherein:

FIG. 1 is a system overview diagram of an online transaction system in accordance with an illustrative embodiment of the present invention;

FIG. 2 is a system overview diagram of the system illustrated in FIG. 1 depicting the interaction between the customer and the transaction server;

FIG. 3 is a system overview diagram of the system illustrated in FIG. 1 depicting the interaction between the customer and selected financial institution;

FIG. 4 depicts an online vendor screen forming part of a user interface displayed in accordance with an illustrative embodiment of the present invention;

FIG. 5 depicts a transaction server screen forming part of a user interface displayed in accordance with an illustrative embodiment of the present invention;

FIG. 6 depicts a financial institution login screen forming part of a user interface displayed in accordance with an illustrative embodiment of the present invention;

FIG. 7 depicts a payment screen forming part of a user interface displayed in accordance with an illustrative embodiment of the present invention;

FIG. 8 is a system flowchart diagram for a method for carrying out an online transaction in accordance with an illustrative embodiment of the present invention; and

FIG. 9 is a system overview diagram of a transaction server in accordance with an illustrative embodiment of the present invention.

In the following description, like reference characters designate like or corresponding parts throughout the several views of the drawings.

### DETAILED DESCRIPTION

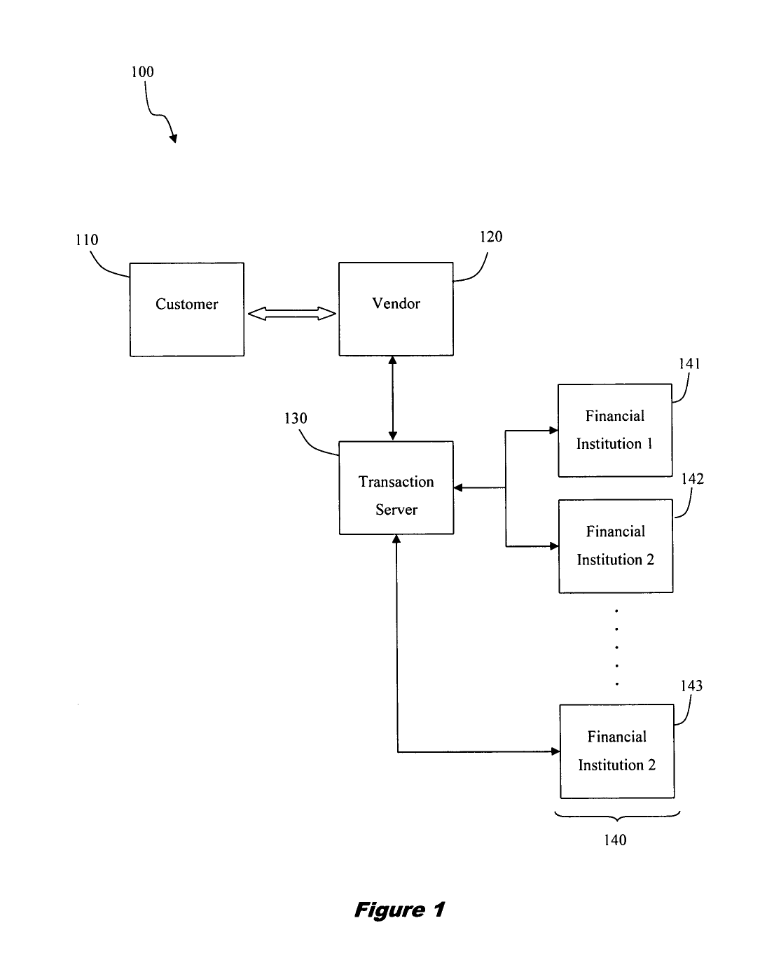

Referring now to FIG. 1, there is shown a system overview diagram of an online transaction system 100 in accordance with an illustrative embodiment of the present invention. In this illustrative embodiment, a customer 110 enters into a financial transaction with an online vendor 120. In this example, the financial transaction is the purchase of an item on the vendor's website but equally the financial transaction could involve the payment of a bill or more generally the payment of an amount for any good or service to be rendered by the vendor. While in this example the online vendor 120 is a website, equally the vendor may be “online” in the sense of being part of a telecommunications network whereby the customer is able to access the vendor's online presence through the use of an access device such as a mobile phone.

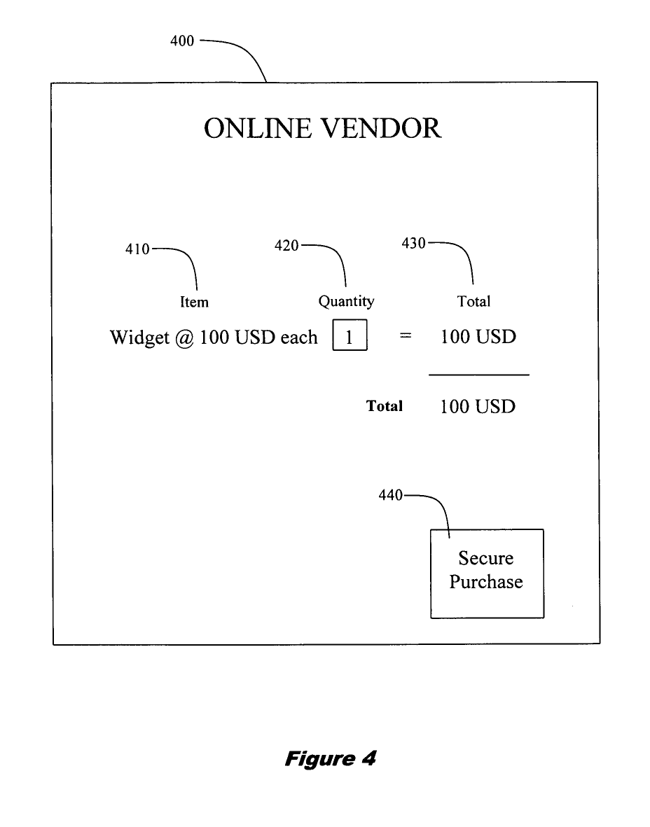

Taking once again the illustrative embodiment of customer 110 purchasing an item from online vendor 120, once the item that is to be purchased has been selected and payment is required, the customer 110 is presented with the option of making a secure anonymous payment at which point a transaction server 130 is invoked or initiated to provide an environment for the secure anonymous payment. Referring now also to FIG. 4 there is shown an online vendor purchase screen 400 forming part of a user interface according to an illustrative embodiment that would be displayed on the computer display of a customer. In this example, online vendor screen involves the selection of an item 410, a quantity of that item 420 and a total amount to be paid 430 such as would be depicted in a web browser or the like, once the item 410 (in this case one widget costing $100 USD) has been selected. The customer is then given the option to carry out the secure anonymous payment by initiating an initiation portion of online vendor screen 400 which in this case is secure purchase button 440.

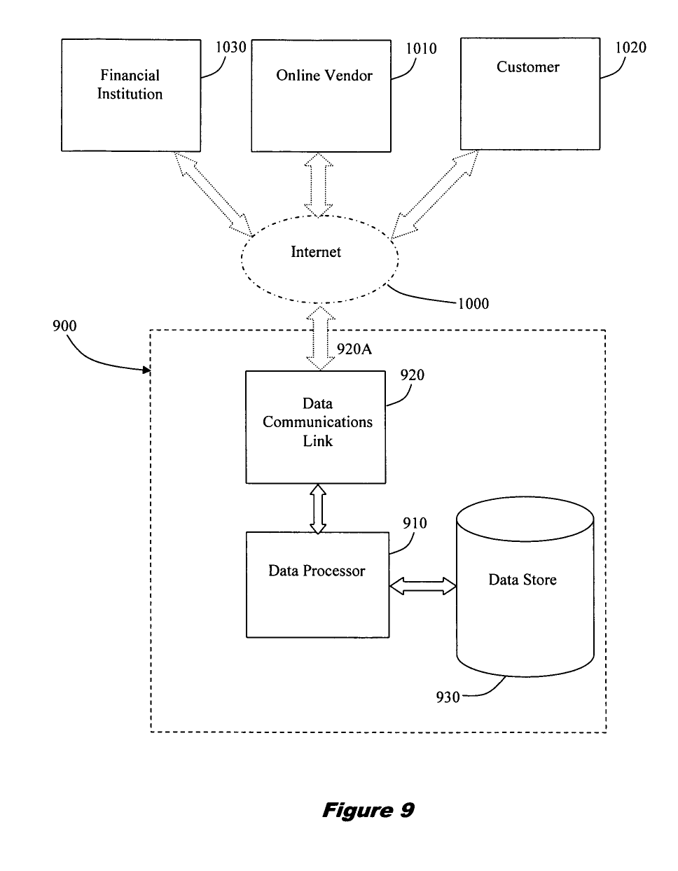

As would be appreciated by those skilled in the art, transaction server 130 may be a separate software entity residing on a remote transaction server processor (e.g. see FIG. 9) and in this instance the initiation process will amount to a call over the network by the online vendor 120 to initiate an instance of the transaction server in a separate webpage. In another embodiment transaction server 130 may be initiated by invoking a software application located on the vendor's website such as a JAVA or .NET application.

To identify the particular purchase a unique transaction reference identifier is generated by transaction server 130 which online vendor 120 uses as a tracking reference to track the transaction and eventually obtain payment from transaction server 130. The generation of the unique transaction reference identifier may employ standard cryptographic techniques as is known in the art.

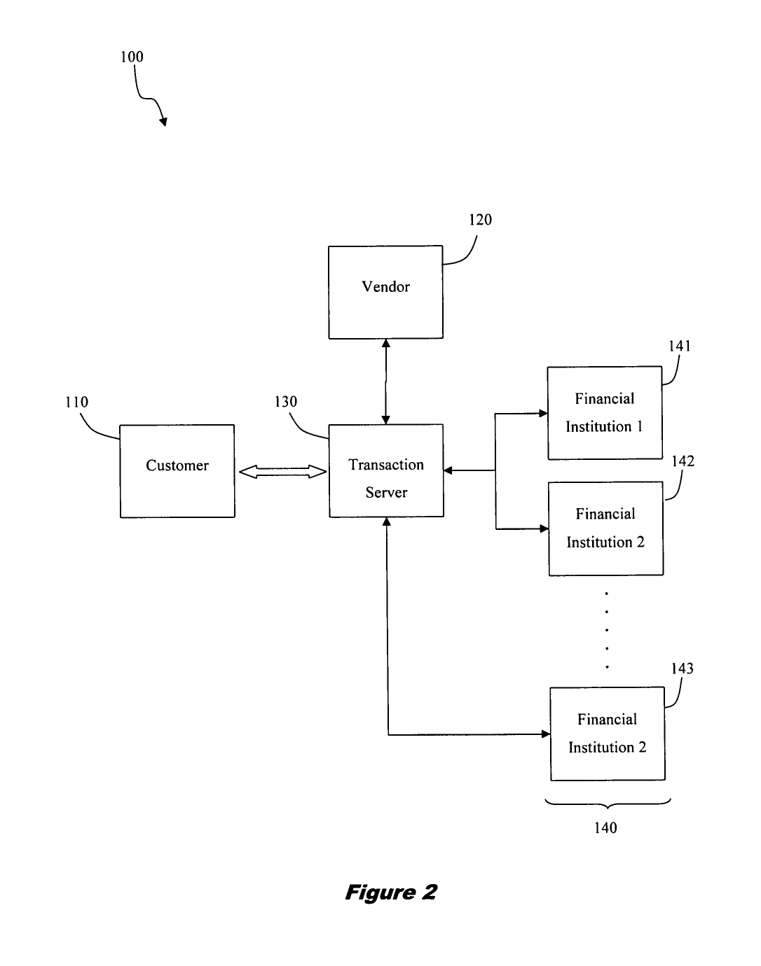

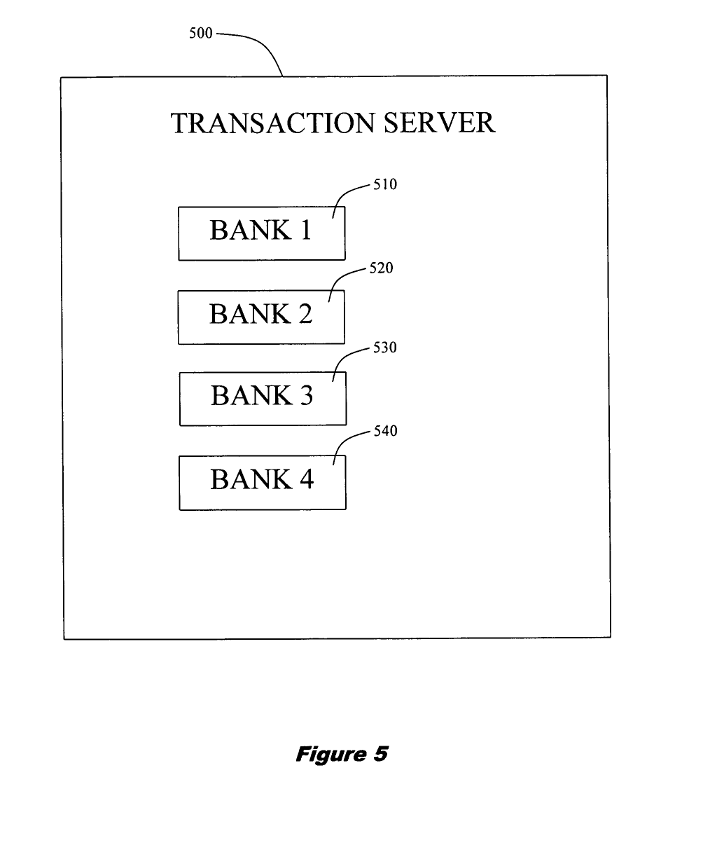

Referring now to FIG. 2, transaction server 130 presents customer 110 with a list of financial institutions 140 from which customer 110 selects their nominated financial institution 141 with whom they have a financial account such as a credit card or standard savings or cheque account. Referring now also to FIG. 5, in this illustrative embodiment, transaction server 130 invokes a transaction server screen 500 in the form of a web page providing selection means in the form of a list of financial institutions in this case “BANK 1” 510, “BANK 2” 520, “BANK 3” 530, “BANK 4” 540 from which the customer 100 is able select from to carry out the online transaction. In another illustrative embodiment, transaction server screen 500 also includes an account selection capability so that a customer could at the outset be directed to their selected account (e.g. a credit card account) following transfer to their nominated financial institution 141.

Following selection of the nominated financial institution 141, transaction server 130 initiates a call to the nominated financial institution 141 to invoke its own interface webpage to allow customer 110 to complete the transaction. In this illustrative embodiment, the nominated financial institution is BANK1 and a secure login screen 600 for BANK 1 is invoked as a result of the transaction server 130 call to BANK 1. Transaction server 130 also calculates a transaction amount based on the purchase amount which is sent as part of the call to the nominated financial institution 141 to invoke its interface webpage.

In this illustrative embodiment, the transaction amount includes a transaction service fee for providing the secure anonymous transaction and a currency conversion fee for conversion into the relevant currency. In one embodiment, the relevant currency can be determined automatically by transaction server 130 based on the nominated financial institution 141 which is selected by customer 110. In another embodiment, customer 110 selects the currency that they wish to settle the transaction.

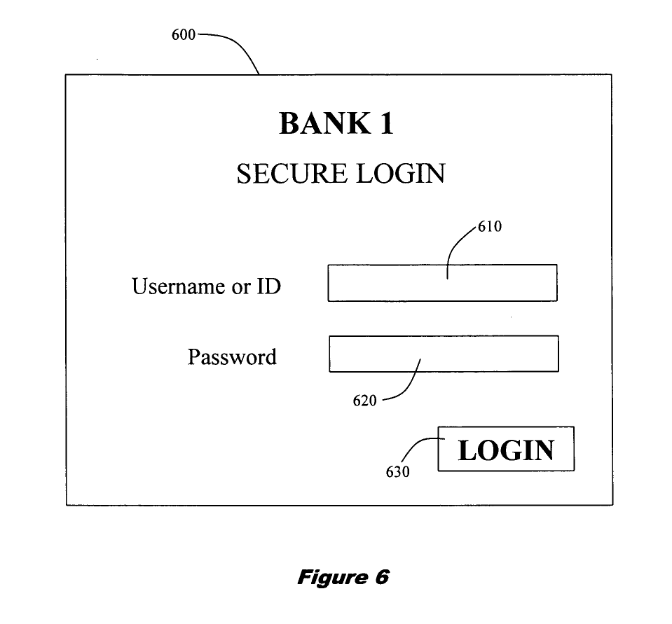

When customer 110 is presented with the interface webpage of their nominated financial institution 141, they logon using the security protocol of their nominated financial institution 141 which may simply involve the use of a personal identification number (PIN), the use of one-time online scramble pads, or the use of a one time security code generated by an electronic device provided by the nominated financial institution 141 or alternatively any combination of these methods. In the case depicted in FIG. 6, customer 110 enters in a username or ID 610 and a password 620 and is prompted to login 630 to the nominated financial institution 141 which in this case is BANK 1. In this manner, the customer 110 only needs to interact with their own nominated financial institution 141 using the relevant logon procedure to access the financial institution and the associated security protocols adopted by that financial institution to guarantee security of the transaction.

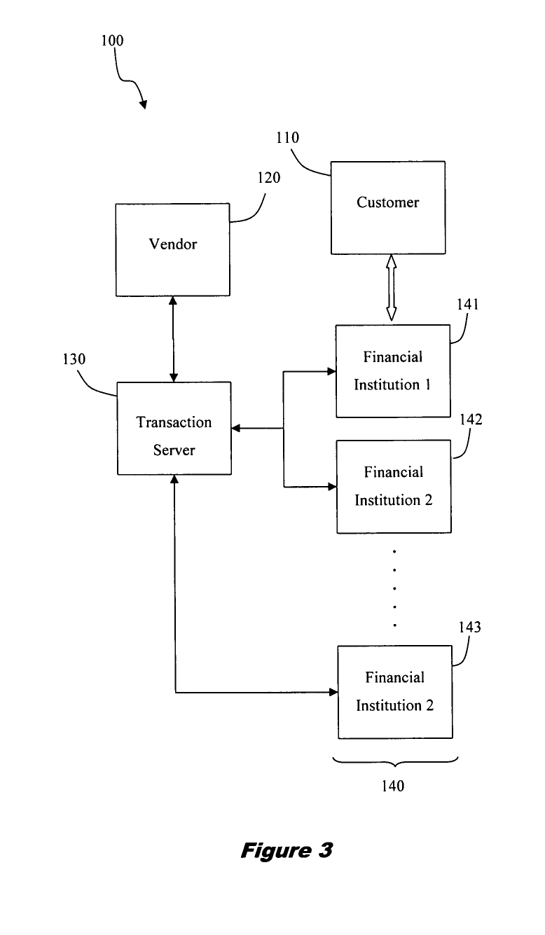

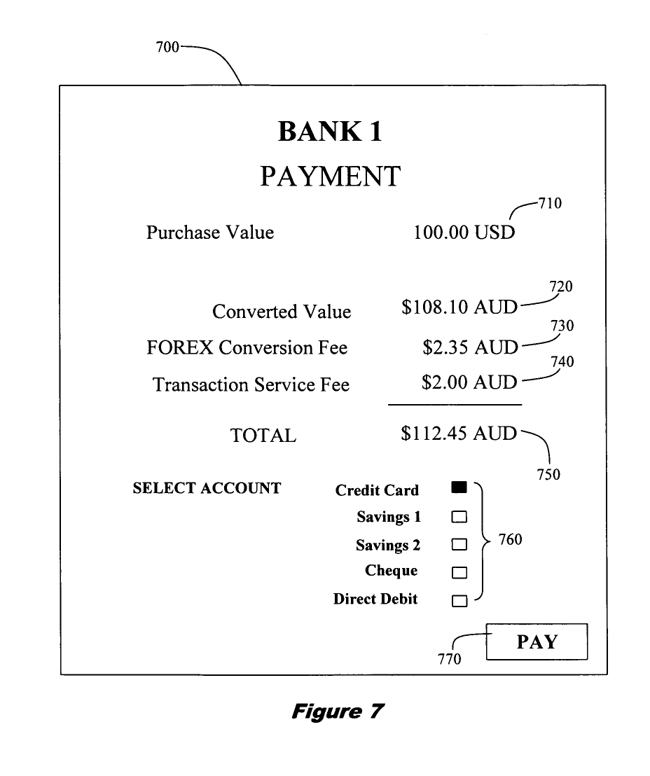

Referring now to FIG. 3, once customer 110 has logged onto the website of the nominated financial institution 141, the transaction amount related to the purchase amount (including in this embodiment the foreign exchange charge and the transaction service fee) is displayed for inspection and approval by the customer 110. Assuming that the transaction amount meets with the customer's approval, customer 110 then pays the transaction amount to transaction server 130 using the standard interface provided by the nominated financial institution 141. In one embodiment as depicted in FIG. 7, a payment screen 700 is displayed indicating the original purchase amount and currency 710, the converted value 720, the foreign exchange conversion fee 730 and the transaction service fee 740 and the total 750 that is to be paid.

In this illustrative embodiment, the customer 110 uses in this example their credit card account at the nominated financial institution 141 by selecting from a list of account payment options 760 including, but not limited to, “Credit Card”, “Savings 1”, “Savings 2”, “Cheque”, “Direct Debit”, displayed on payment screen 700 and then selecting payment by pushing the “PAY” button 770 on payment screen 700. In this case, the transaction amount is settled more or less instantaneously with the transaction server 130 which then notifies the online vendor 120 using the unique transaction reference identifier that the payment has been authorised and that delivery of the item may occur. At this stage, transaction server 130 can transfer the purchase amount to the online vendor's own bank account or alternatively advise online vendor 120 that they may invoice the entity controlling the transaction server 130 using the unique transaction reference identifier to identify the transaction.

In a further embodiment, the customer 110 carries out an electronic funds transfer (e.g. from “Savings 1” or “Savings 2” or “Cheque” as illustrated on payment screen 700) for the transaction amount to the transaction server 130 using the standard interface provided by the nominated financial institution 141. In this example, there may be some delay in settling of the transaction amount between the nominated financial institution 141 and transaction server 130. However, once the transaction amount has been settled then transaction server 130 notifies online vendor 120 that payment has been completed.

As described previously, the transaction amount includes a transaction service fee 740 and a currency conversion charge 730 which are paid by the customer 110 on approval of the transaction at their nominated financial institution 141. As funds are paid from the nominated financial institution 141 of the customer 110 to the financial institution of transaction server 130 and then paid by the financial institution of transaction server 130 to the vendor's financial institution, transaction server 130 is able to then retain the transaction service fee 740 as payment for the provision of the service. In addition, transaction server 130 may retain all of the currency conversion fee 730 or divide a proportion of this fee with the nominated financial institution 141.

In another illustrative embodiment, online vendor 120 would also pay a fee to transaction server 130 per transaction on the basis that the service provided by transaction server 130 will increase turnover. In another illustrative embodiment, the providers of the transaction server 130 may provide a percentage of the transaction service fee 740 to the online vendor as part of a promotional offer to have the vendor adopt this service.

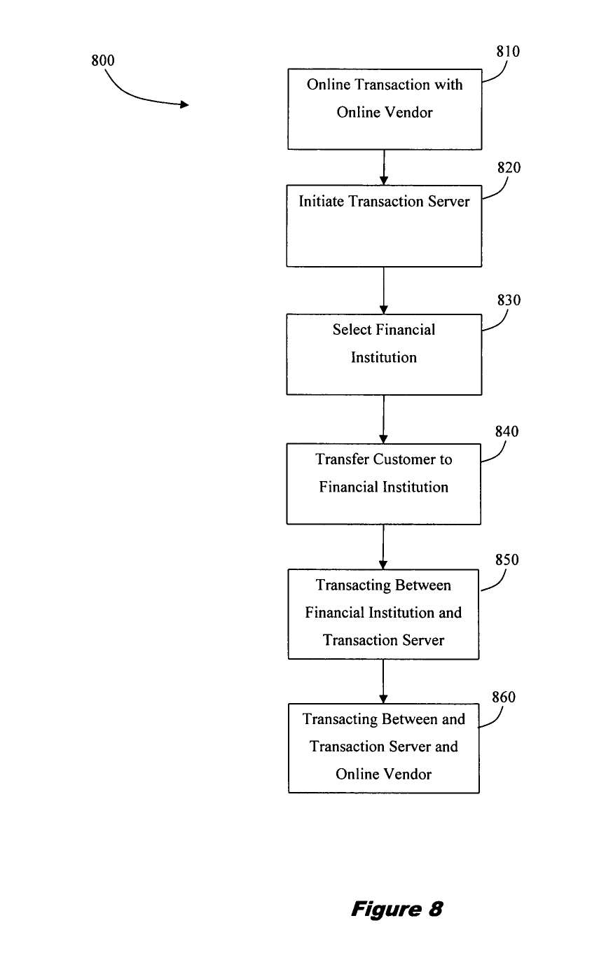

Referring now to FIG. 8, there is shown a system flowchart of a method 800 for carrying out an online transaction between a customer having a financial account with a nominated financial institution and an online vendor according to an illustrative embodiment of the present invention. At step 810, an online transaction is carried out by a customer with an online vendor. The transaction may be for the purchase of any good or service. Typically, the online transaction would involve the display of an online vendor purchase screen by the online vendor such as that depicted in FIG. 4 on the customer's computer display which nominates the type of good and/or service being purchased and the required purchase amount.

Once a customer has indicated that they wish to purchase a good and/or service, a transaction server is initiated by the online vendor at step 820 for the customer to conduct the online transaction. In one illustrative embodiment, the transaction server further invokes a transaction server screen that is displayed on the computer display of the computer being used to carry out the online transaction. As has been described previously, typically the transaction server selection interface is a web page that is viewed on the web browser of the customer that sets out a number of financial institutions including the nominated finanction institution that a customer may select from to carry out the online transaction. An example of such a screen is depicted in FIG. 5.

At step 830, the customer selects their financial institution at which point the customer is transferred to the nominated financial institution at step 840. In one illustrative embodiment, this transfer includes the nominated financial institution then invoking its own interface web page for the customer to log onto (e.g. see FIG. 6). Once the customer has been transferred to their financial institution, at step 850 a first transaction is then carried out between the nominated financial institution and the transaction server for a transaction amount related to the original purchase amount.

In one illustrative embodiment, the transfer by the transaction server to the nominated financial institution includes the calculation of the transaction amount which may include a further transaction service fee and/or foreign exchange fee in the event that the original purchase is carried out in a different currency from the operating currency of the nominated financial institution. The customer may then select to carry out the first transaction by use of a credit card or the use of electronic funds transfer depending on what facilities the customer has with the financial institution (e.g. see FIG. 7)

Following the first transaction, at step 860 a further transaction may then be carried out with the online vendor's financial institution for the purchase amount in satisfaction of the online transaction. As would be appreciated by those of ordinary skill in the art, the vendor's financial institution may be a traditional financial institution such as a bank or alternatively the vendor may operate a PayPal™ or similar online account where monies may be paid into in satisfaction of the online transaction. In another embodiment, the further transaction may involve authorising the online vendor to invoice the entity operating the transaction server the purchase amount of the online transaction.

Referring now to FIG. 9, there is shown a system overview diagram of a transaction server processor 900 according to an illustrative embodiment of the present invention. In this example, transaction server 900 is a standalone server incorporating a central processing unit (CPU) 910, a secure data store 930 and a data communications link 920 which is this embodiment connects 920A transaction server processor 900 to the Internet 1000. The data processor 910 is operable to carry out the various steps of the method and system of the present invention by communicating with the computer systems of the customer 1020, online vendor 1010 and the financial institution 1030 and where appropriate calculating and providing associated fee and display information and monitoring customer inputs.

Alternatively, the functionality of the transaction server processor 900 may in part be distributed over the computer systems of the customer 1020, online vendor 1010 or the financial institution 1030 by employing embedded code that may include, but not be limited to PHP, JAVA, .NET or ASP code, that is provided by the transaction server processor 900 over the Internet 1000 to be then executed on one or more of these systems in accordance with the present invention with data associated with the transactions stored on secure data store 930.

As would be appreciated by those skilled in the art, the transaction server processor 900 and the computer systems of the online vendor 1010, customer 1020 and financial institution 1030 may communicate and authenticate over the Internet 1000 using secure communication protocols including but not limited to transport layer security (TLS), secure socket layer (SSL), secure shell (SSH), internet protocol security (IPSec), server-gated cryptography (SGC) protocol, secure electronic transaction (SET) protocol. Alternatively, and/or in addition to, the system and method of the present invention may be implemented over proprietary networks or protocols such as the Society for Worldwide Interbank Financial Telecommunication (“SWIFT”) worldwide financial messaging network SWIFTNet™ or Verizon™ Financial Network (VFN).

Online transaction system 100 provides a number of significant advantages over prior art systems. One advantage for credit card users is that their credit card details are only ever used when interacting with their own nominated financial institution, thereby ensuring that these details only ever stay with a trusted entity. In addition, a further significant advantage is that any financial transaction will occur in accordance with the standard logon security protocol that the customer will be familiar with when interacting with their nominated financial institution further enhancing the security of the transaction.

Another advantage is the increased anonymity of the financial transaction when compared to standard online credit card transactions. This is due to the vendor not knowing directly the identity of the customer carrying out the transaction as the transaction server coordinates

[symbol]

1. A method for carrying out an online transaction between a customer having a financial account with a nominated financial institution and an online vendor, the method including:
initiating a transaction server by the online vendor for the customer to conduct the online transaction for a purchase amount;
selecting by the customer the nominated financial institution from a list of financial institutions provided by the transaction server;
transferring by the transaction server the customer to the nominated financial institution on selection of the nominated financial institution;
transacting between the nominated financial institution and the transaction server a first financial transaction for a transaction amount related to the purchase amount; and
further transacting between the transaction server and the online vendor's financial institution a second transaction for the purchase amount in satisfaction of the online transaction.

2. The method of claim 1, wherein the step of transferring by the transaction server the customer to the nominated financial institution includes the nominated financial institution invoking its own interface page for the customer to access the nominated financial institution.

3. The method of claim 1, wherein the step of transacting between the nominated financial institution and the transaction server includes the customer selecting the financial account from which to carry out the first financial transaction.

4. The method of claim 3, wherein the financial account is a credit card account and the first financial transaction is a credit card transaction.

5. The method of claim 3, wherein the financial account is a savings or checking account and the first financial transaction is an electronic funds transfer.

6. The method of claim 1, wherein the step of transferring the customer by the transaction server to the nominated financial institution includes calculating the transaction amount and providing the transaction amount to the nominated financial institution.

7. The method of claim 6, wherein the step of calculating the transaction amount includes incorporating a transaction service fee.

8. The method of claim 6, wherein the step of calculating the transaction amount includes incorporating a currency conversion fee.

9. A system for carrying out an online transaction between a customer having a financial account with a nominated financial institution and an online vendor, the system including:
a transaction server initiated by the online vendor for the customer to conduct the online transaction for a purchase amount;
the transaction server providing selection means to allow the customer to select the nominated financial institution from a list of financial institutions provided by the transaction server;
the transaction server operable to transfer the customer to the nominated financial institution on selection of the nominated financial institution;
the transaction server operable to carry out a first transaction between the nominated financial institution and the transaction server for a transaction amount related to the purchase amount; and
the transaction server then operable to carry out a second transaction between the transaction server and the online vendor's financial institution for the purchase amount in satisfaction of the online transaction.

10. The system of claim 9, wherein on transferring by the transaction server of the customer to the nominated financial institution, the nominated financial institution invokes its own interface page for the customer to access the nominated financial institution.

11. The method of claim 9, wherein the transaction between the nominated financial institution and the transaction server includes selection means for the customer to select the financial account from which to carry out the first financial transaction.

12. The method of claim 11, wherein the financial account is a credit card account and the first financial transaction is a credit card transaction.

13. The method of claim 11, wherein the financial account is a savings or checking account and the first financial transaction is an electronic funds transfer.

14. The method of claim 9, wherein on transferring by the transaction server of the customer to the nominated financial institution, the transaction server calculates the transaction amount and provides the transaction amount to the nominated financial institution.

15. The method of claim 14, wherein the transaction amount includes a transaction service fee.

16. The method of claim 14, wherein the transaction amount includes a currency conversion fee.

17. A user interface for carrying out an online transaction between a customer having a financial account with a nominated financial institution and an online vendor, the user interface implemented on a computer display operated by the customer, the user interface including:
an online vendor screen displayed on the computer display and provided by the online vendor to conduct the online transaction for a purchase amount, the online vendor screen including a initiating portion operable by the customer for displaying a transaction server screen on the computer display, the transaction server screen provided by a transaction server and including a selection portion to allow the customer to select the nominated financial institution from a list of financial institutions;
a login screen displayed on the computer display, the login screen provided by the nominated financial institution on selection of the nominated financial institution; and
a payment screen provided by the nominated financial institution to carry out a transaction for a transaction amount in satisfaction of the online transaction with the online vendor.

18. The user interface of claim 17, wherein the payment screen includes a display of a transaction service fee for inclusion in the transaction amount.

19. The user interface of claim 18, wherein the payment screen includes a display of a currency conversion fee for inclusion in the transaction amount.

20. The user interface of claim 17, wherein the payment screen includes a list of accounts of the customer for payment of the transaction amount.

21. The user interface of claim 17, wherein the user interface is implemented to be accessed by a web browser.
